(19) United States
(12) Patent Application Publication
(10) Pub. No.: US 2017/0235844 A1
(43) Pub. Date: Aug. 17, 2017

(54) DEVICE HAVING MULTIPLE PLATFORMS FOR FACILITATING CONNECTION TO A URL

(71) Applicant: Jack Chmela, Oak Lawn, IL (US)

(72) Inventor: Jack Chmela, Oak Lawn, IL (US)

(21) Appl. No.: 15/426,132

(22) Filed: Feb. 7, 2017

Related U.S. Application Data
(60) Provisional application No. 62/294,073, filed on Feb. 11, 2016.

(51) Int. Cl. G06F 17/30; G06K 7/14; G06K 7/00; G06K 7/10; G06Q 30/02; H04M 1/725

(52) U.S. Cl. CPC G06F 17/30879; G06Q 30/0277; H04M 1/72561; G06K 7/0004; G06K 7/10386; G06F 17/30887; G06K 7/1417; G06K 7/10297

(57) ABSTRACT

A device having multiple platforms for enabling a smart device, such as a smart phone, to access a URL having specified information. The device includes a scannable symbol or image for use by an image reader in the smart device. The device also includes a chip or tag that can be read by the smart device that also facilitates accessing the URL. The device can be embodied in a business card, keychain fob or other similar item.

### CROSS-REFERENCE TO RELATED APPLICATIONS

The present invention claims the benefit of U.S. Provisional Patent Application No. 62/294,073, filed Feb. 11, 2016, the contents of which are incorporated herein by reference.

### FEDERALLY SPONSORED RESEARCH OR DEVELOPMENT

N/A

### FIELD OF THE INVENTION

The present invention is directed to an item (i.e., device), such as a business card, keychain fob or other similar device that provides multiple platforms for facilitating access to a URL or website containing specialized information.

### DESCRIPTION OF THE PRIOR ART

Sales, especially of high priced items such as cars, rely on a large number of factors. Marketing, sales personnel, third party reviews and other related information regarding the item for purchase, etc. all come into play in making the sale. Providing access to information regarding the sale, the item for sale or any other aspect of the sale can enhance a potential customer's experience and make the sale easier. Moreover, providing some additional service or value, can further facilitate making the sale.

The present invention provides a unique device that can quickly connect a customer or potential customer to sale specific information, or other useful information relating to the sale or item for sale on a website.

### SUMMARY OF THE INVENTION

The present invention is directed to an item or device, such as a business card, credit card, keychain fob or other similar device that includes or provides multiple platforms or methods for facilitating access to a web site or URL containing specialized information (e.g., of a sale item, such as a car). The device enables a smart device, such as a smart phone or pad, to quickly navigate a web browser in the smart device to access the URL. The device of the present invention can be implemented to facilitate a business deal, such as the sale of a car, and enable a user to quickly obtain information relating to the car as well as other useful information (e.g., the dealership, service, car history, Owner's Manual, etc.).

In accordance with one aspect of the invention, a device is provided that has multiple platforms for facilitating access to a website. The device comprises a symbol scannable by a smart device. The symbol is configured to activate software in the smart device to navigate a web browser to a specific URL having specific information relative to the device's use (e.g., car data). The device also includes a tag that is readable by a smart device. The tag is also configured to activate software in the smart device to navigate to the specific URL.

The device can also have indicia for facilitating access of the URL by the smart device. The indicia can be a texting message that when utilized by the smart device links the smart device to the URL. Alternatively, or in addition, the indicia can be the URL, in which case a user can enter the URL into the smart device.

The multiple platforms can be embodied in a business card. Alternatively, the multiple platforms can be embodied in a keychain fob. Other similar items can also be used to embody the multiple platforms.

The symbol on the device can be a matrix barcode, such as a Quick Response (QR) code.

The tag in the device can utilize near field communication technology.

In accord with one aspect of the invention, the device is configured to enable a smart phone to access the URL.

Other aspects of the invention are shown in the figures and discussed in the description and claims.

### BRIEF DESCRIPTION OF THE DRAWINGS

To understand the present invention, it will now be described by way of example, with reference to the accompanying drawings in which:

FIG. 1 is a business card having multiple platforms for facilitating access to an URL in accordance with aspects of the present invention;

FIG. 2 is a keychain fob having multiple platforms for facilitating access to an URL in accordance with aspects of the present invention;

FIG. 3 illustrates a bar matrix barcode and other indicia for connecting to a URL for placement on a device in accordance with the present application; and

FIG. 4 is a smart phone for use with the device of the present invention.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

The present invention is a device that facilitates navigation to a website or URL that contains specific information relevant to a transaction or other similar interaction. The device contains multiple platforms or methods for connecting a smart device to the website.

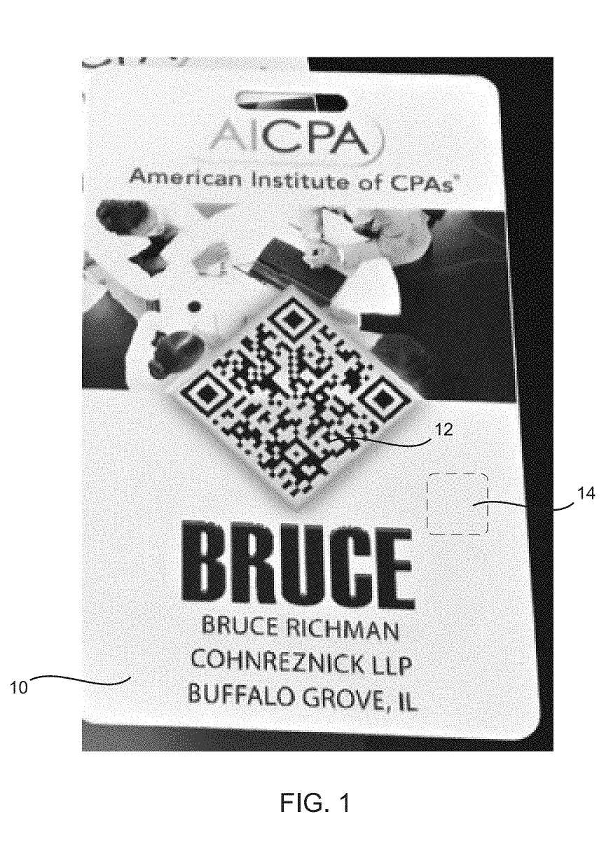

In accordance with one form of the device, FIG. 1 shows a business card 10 having multiple platforms for connecting to a website. A first platform is in the form of a matrix barcode 12 (such as a QR code) on a first side of the business card 10. The matrix barcode is configured to cooperate with a barcode scanner on a smart device, such as a smart phone, pad, or other similar device. Scanning the matrix barcode 12 using the smart phone causes a web browser on the smart phone to navigate to a designated website or URL.

A second platform is also provided on the business card 10. The second platform can be in the form of a chip 14 on or embedded in the business card 10. The chip 14 (shown in phantom on the business card 10 of FIG. 1) can communicate with or be read by an application on the smart phone or other similar device to, again, cause a web browser to navigate to the website or URL. The chip 14 can use near field communication (NFC) or other similar communication protocol. In some forms of the invention, the card could use Bluetooth technology. Additionally, the tag could be an RFID tag (either active or passive). With the chip 14 in place, the business card can be tapped to (or otherwise brought proximate) an appropriate reader in the smart device.

The business card 10 can provide additional platforms for connecting to the appropriate website. For example, as illustrated in FIG. 3, the business card 10 can include indicia identifying a text word/phone number 16 for connecting to the URL, or an actual URL 18. The indicia can be entered into the appropriate applications on the smart device (i.e., texting function and web browser, respectively) to access the URL.

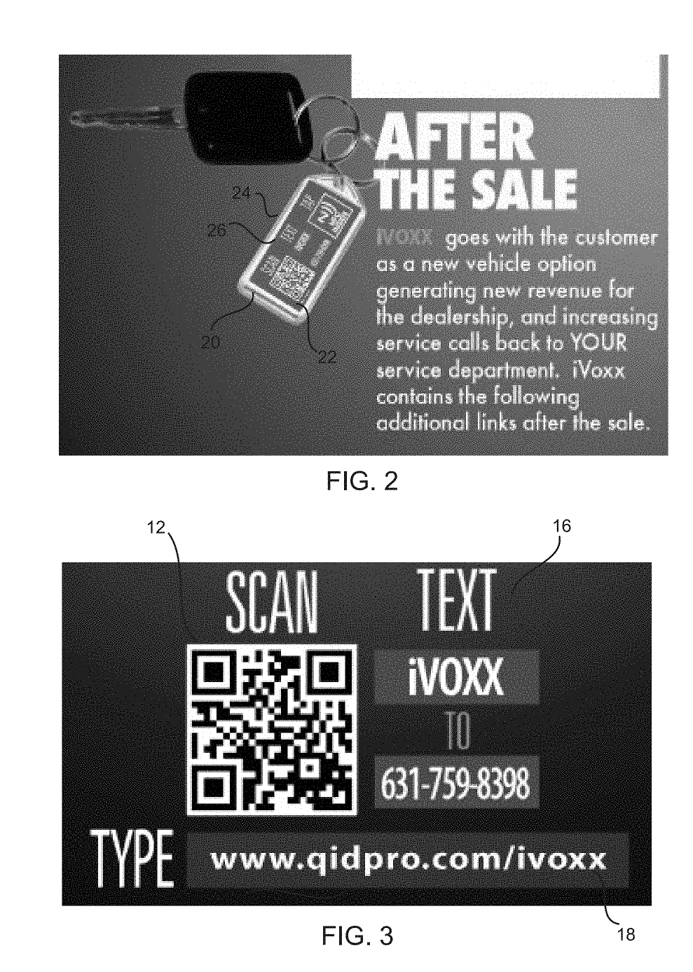

FIG. 2 illustrates another embodiment of the device as a keychain fob 20. The keychain fob includes a first platform in the form of a matrix barcode 22, a second platform in the form of a chip 24 and a third and fourth platform in the form of indicia 26. The platforms operate in the same manner as described above with respect to the business card 10.

The device can be similarly included in or made part of other similar items as the business card 10 and keychain fob 20. Such items can include a credit card or other small marketing item or give-away.

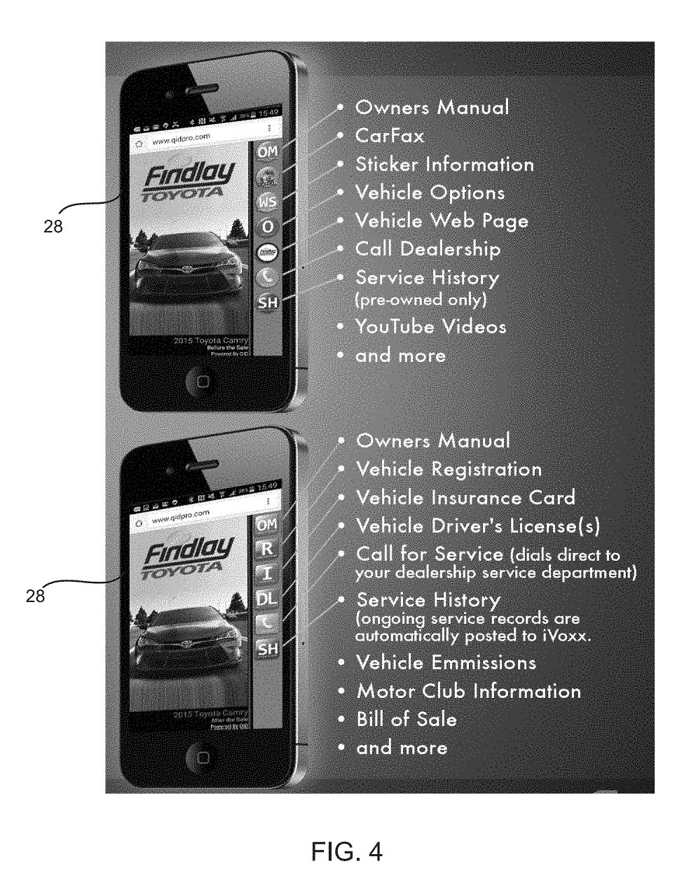

FIG. 4 illustrates a smart device in the form of a smart phone 28 having a web browser (shown on a display 30) connected to a URL via one of the platforms of the present device (e.g., business card 10, keychain fob 20, or other similar item incorporating the various connection platforms). The smart device includes typical standard features (e.g., wi-fi, apps, etc). The type of information provided at the website can vary depending on the status of the item for sale. For example, the website can include information about a car and include information that could facilitate a sale of the car (e.g. a Carfax report, Vehicle Options, etc.). Once a sale is complete, the website can be updated to include other information important to the new car owner (e.g., Bill of Sale, Vehicle Registration, Owner's Manual, etc.).

Additionally, password protection can be built into any of the platforms.

Many modifications and variations of the present invention are possible in light of the above teachings. It is, therefore, to be understood within the scope of the appended claims the invention may be protected otherwise than as specifically described.

I claim:

1. A device having multiple platforms for facilitating access to a website comprising:
a symbol scannable by a smart device, wherein the symbol activates software in the smart device to navigate to a specific URL; and, a tag readable by a smart device, wherein the tag activates software in the smart device to navigate to the specific URL.

2. The device of claim 1 further comprising indicia for facilitating access of the URL by the smart device.

3. The device of claim 2 wherein the indicia includes a texting message that when utilized by the smart device links the smart device to the URL.

4. The device of claim 2 wherein the indicia includes the URL.

5. The device of claim 1 wherein the multiple platforms are embodied in a business card.

6. The device of claim 1 wherein the multiple platforms are embodied in a keychain fob.

7. The device of claim 1 wherein the symbol is a matrix barcode.

8. The device of claim 7 wherein the matrix barcode is a QR code.

9. The device of claim 1 wherein the tag utilizes near field communication.

10. The device of claim 1 wherein the device is configured to enable a smart phone to access the URL.

11. A device having multiple platforms for connecting a smart phone to a website having specific information relating to an item for sale comprising:
a scannable symbol on the device configured to cooperate with a scanning feature of the smart phone to cause a web browser in the smart phone to navigate to a specific website having information relating to the item for sale;
a chip connected to the device configured for enabling the web browser of the smart phone to navigate to the website;
indicia on the device for input into the smart phone for enabling the web browser of the smart phone to navigate to the website.

12. The device of claim 11 wherein the scannable symbol, chip and indicia are on a business card.

13. The device of claim 11 wherein the scannable symbol, chip and indicia are on a keychain fob.

14. The device of claim 11 wherein the scannable symbol is a bar matrix code.

15. The device of claim 11 wherein the chip utilizes near field communication.
